(19) United States
(12) Patent Application Publication
(10) Pub. No.: US 2017/0082571 A1
(43) Pub. Date: Mar. 23, 2017

(54) METHOD FOR DETECTING L-TYROSINE BY USING GRAPHENE-MODIFIED GRAPHITE PENCIL ELECTRODE SYSTEM

(71) Applicant: KING FAHD UNIVERSITY OF PETROLEUM AND MINERALS, Dhahran (SA)

(72) Inventors: Abdel-Nasser Metwally Aly KAWDE, Dhahran (SA); Nadeem BAIG, Dhahran (SA)

(73) Assignee: KING FAHD UNIVERSITY OF PETROLEUM AND MINERALS, Dhahran (SA)

(21) Appl. No.: 14/857,057

(22) Filed: Sep. 17, 2015

(51) Int. Cl. G01N 27/327; G01N 27/48; G01N 27/30

(52) U.S. Cl. CPC G01N 27/3275; G01N 27/308; G01N 27/48

(57) ABSTRACT

A graphene-modified graphite pencil electrode (GPE) system and a method for detecting L-tyrosine in a solution. The electrode system includes a graphene-modified graphite pencil working electrode comprising a graphite pencil base electrode and a layer of graphene comprising wrinkled graphene sheets on the surface of the graphite pencil base electrode, a counter electrode, and a reference electrode. The method comprises contacting the solution with the graphene-modified GPE system and conducting voltammetry, preferably square wave voltammetry, to detect the L-tyrosine concentration in the solution.

### BACKGROUND OF THE INVENTION

Technical Field

The present disclosure relates to a graphene (GR)-modified graphite pencil electrode (GPE) system and a method for detecting L-tyrosine in a solution. The graphene-modified graphite pencil electrode system includes a graphene-modified graphite pencil working electrode comprising a graphite pencil base electrode and a layer of graphene comprising wrinkled graphene sheets on the surface of the graphite pencil base electrode, a counter electrode, and a reference electrode. The method for detecting L-tyrosine in a solution comprises contacting the solution with the graphene-modified graphite pencil electrode system and conducting voltammetry to detect the L-tyrosine concentration in the solution.

Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, is neither expressly nor impliedly admitted as prior art against the present invention.

L-tyrosine is an essential amino acid with significant importance in the body. Its presence is crucial to regulating protein synthesis. L-tyrosine assists the maintenance of a positive nitrogen balance in the body (See K.-J. Huang, D.-F. Luo, W.-Z. Xie, Y.-S. Yu, Sensitive voltammetric determination of tyrosine using multi-walled carbon nanotubes/4-aminobenzeresulfonic acid film-coated glassy carbon electrode, Colloids Surf. B. Biointerfaces. 61 (2008) 176-81, incorporated herein by reference in its entirety). Tyrosine is a precursor to several neurotransmitters, such as norepinephrine, dopamine, and epinephrine, and to hormones such as thyroxin, a critical thyroid hormone (See J. D. Fernstrom, M. H. Fernstrom, Tyrosine, phenylalanine, and catecholamine synthesis and function in the brain, J. Nutr. 137 (2007) 1539S-1547S; discussion 1548S; L. Jiang, S. Gu, Y. Ding, D. Ye, Z. Zhang, F. Zhang, Amperometric sensor based on tricobalt tetroxide nanoparticles-graphene nanocomposite film modified glassy carbon electrode for determination of tyrosine, Colloids Surf. B. Biointerfaces. 107 (2013) 146-51; Y. Fan, J.-H. Liu, H.-T. Lu, Q. Zhang, Electrochemistry and voltammetric determination of L-tryptophan and L-tyrosine using a glassy carbon electrode modified with a Nation/TiO₂-graphene composite film, Microchim. Acta. 173 (2011) 241-247, each incorporated herein by reference in their entirety). L-tyrosine is added to foods, pharmaceuticals, and dietary products (See R. Nie, X. Bo, H. Wang, L. Zeng, L. Guo, Chiral electrochemical sensing for tyrosine enantiomers on glassy carbon electrode modified with cysteic acid, Electrochem. Commun. 27 (2013) 112-115, incorporated herein by reference in its entirety). The metabolic stability of the nicotinic acetylcholine receptor in the muscles is controlled by the phosphotyrosine level (See a Sava, I. Barisone, D. Di Mauro, G. Fumagalli, C. Sala, Modulation of nicotinic acetylcholine receptor turnover by tyrosine phosphorylation in rat myotubes., Neurosci. Lett. 313 (2001) 37-40, incorporated herein by reference in its entirety). Foods with a high tyrosine content include cheese, soybeans, beef, lamb, pork, fish, chicken, nuts, seeds, eggs, dairy, beans, and whole grains. Tyrosine is produced in the body by phenylalaninase from phenylalanine. The absence of this enzyme favors the production of phenylpyruvic acid, which can cause mental retardation (See Q. Xu, S.-F. Wang, Electrocatalytic Oxidation and Direct Determination of L-Tyrosine by Square Wave Voltammetry at Multi-wall Carbon Nanotubes Modified Glassy Carbon Electrodes, Microchim. Acta. 151 (2005) 47-52, incorporated herein by reference in its entirety). Sister chromatid exchange in the culture medium may increase at high concentrations of L-tyrosine (See C. Li, Voltammetric determination of tyrosine based on an L-serine polymer film electrode, Colloids Surf. B. Biointerfaces. 50 (2006) 147-51, incorporated herein in its entirety). The absence of tyrosine causes depression. L-tyrosine is involved in several diseases, such as alkaptonuria, albinism, mental illness, lung disease, liver disease, and tyrosinemia (See G. G. Huang, J. Yang, Development of infrared optical sensor for selective detection of tyrosine in biological fluids, Biosens. Bioelectron. 21 (2005) 408-18, incorporated herein by reference in its entirety). L-tyrosine excretion in the urine increased in patients suffering from diabetes mellitus (See Molnár G A, Wagner Z, Marko L, Kó Szegi T, Mohás M, Kocsis B, Matus Z, Wagner L, Tamaskó M, Mazák I, Laczy B, Nagy J, Wittmann I., Urinary ortho-tyrosine excretion in diabetes mellitus and renal failure: Evidence for hydroxyl radical production, Kidney Int. 68 (2005) 2281-2287, incorporated herein by reference in its entirety). Several investigations have reported that tyrosine is useful for treating fatigue, cold, stress, and wakefulness (See M. Arvand, T. M. Gholizadeh, Simultaneous voltammetric determination of tyrosine and paracetamol using a carbon nanotube-graphene nanosheet nanocomposite modified electrode in human blood serum and pharmaceuticals, Colloids Surf. B. Biointerfaces. 103 (2013) 84-93; S. Hao, Y. Avraham, O. Bonne, E. M. Berry, Separation-induced body weight loss, impairment in alternation behavior, and autonomic tone: effects of tyrosine., Pharmacol. Biochem. Behay. 68 (2001) 273-81, each incorporated herein by reference in their entirety). Tyrosine is used in protein supplements to treat an inherited disorder called phenylketonuria (PKU). People who have this disorder can't process phenylalanine properly. As a result, they can't make tyrosine. To meet their bodies' needs, supplemental tyrosine is given. L-tyrosine capsules are sold as a dietary supplement. Some people also apply tyrosine to the skin to reduce age-related wrinkles. The importance of L-tyrosine for health and nutrition requires sensitive, rapid, reproducible, and low cost methods to be developed to detect and quantify L-tyrosine. The solubility of L-tyrosine in water (25° C.) is 0.45 mg/ml, or about 2.48 mM, in the pH range 3.2-7.5.

Several methods have been designed and reported for the determination of L-tyrosine in biological samples and pharmaceutical products. These methods are mainly based on liquid chromatography-tandem mass spectrometry, gas chromatography, chemiluminescence, high-performance liquid chromatography-fluorescence or ultraviolet (UV) detection, fluorimetry, and spectrophotometric and capillary electrophoresis (See N. M. Felitsyn, G. N. Henderson, M. O. James, P. W. Stacpoole, Liquid chromatography-tandem mass spectrometry method for the simultaneous determination of delta-ALA, tyrosine and creatinine in biological fluids, Clin. Chim. Acta. 350 (2004) 219-30; S. Bouchet, E. Chauzit, D. Ducint, N. Castaing, M. Canal-Raffin, N. Moore, et al., Simultaneous determination of nine tyrosine kinase inhibitors by 96-well solid-phase extraction and ultra performance LC/MS-MS, Clin. Chim. Acta. 412 (2011) 1060-7; M. C. Sanfeliu Alonso, L. Lahuerta Zamora, J. Martinez Calatayud, Determination of tyrosine through a FIA-direct chemiluminescence procedure, Talanta. 60 (2003) 369-76; M. Lee, H. Nohta, Y. Umegae, Y. Ohkura, Assay for tyrosine hydroxylase by high-performance liquid chromatography with fluorescence detection, J. Chromatogr. 415 (1987) 289-96; D. I. Sanchez-Machado, B. Chavira-Willys, J. Lopez-Cervantes, High-performance liquid chromatography with fluorescence detection for quantitation of tryptophan and tyrosine in a shrimp waste protein concentrate, J. Chromatogr. B. Analyt. Technol. Biomed. Life Sci. 863 (2008) 88-93; M. Sa, L. Ying, A.-G. Tang, L.-D. Xiao, Y.-P. Ren, Simultaneous determination of tyrosine, tryptophan and 5-hydroxytryptamine in serum of MDD patients by high performance liquid chromatography with fluorescence detection, Clin. Chim. Acta. 413 (2012) 973-7; G. Neurauter, S. Scholl-Bürgi, A. Haara, S. Geisler, P. Mayersbach, H. Schennach, et al., Simultaneous measurement of phenylalanine and tyrosine by high performance liquid chromatography (HPLC) with fluorescence detection, Clin. Biochem. 46 (2013) 1848-51; X. Mo, Y. Li, A. Tang, Y. Ren, Simultaneous determination of phenylalanine and tyrosine in peripheral capillary blood by HPLC with ultraviolet detection, Clin. Biochem. 46 (2013) 1074-8; C. Acta, Y. Universcty, Chcmica Acta, 224 (1989) 133-138, Anal. Chim. Acta,. 224 (1989) 133-138; C. Bayle, N. Sifi, V. Poinsot, M. Treilhou, E. Caussë, F. Couderc, Analysis of tryptophan and tyrosine in cerebrospinal fluid by capillary electrophoresis and “ball lens” UV-pulsed laser-induced fluorescence detection, J. Chromatogr. A. 1013 (2003) 123-30; Y. Huang, X. Jiang, W. Wang, J. Duan, G. Chen, Separation and determination of 1-tyrosine and its metabolites by capillary zone electrophoresis with a wall-jet amperometric detection, Talanta. 70 (2006) 1157-63, each incorporated herein by reference in their entirety). Although all these methods display a good accuracy, most of them are tedious, require several preparatory steps prior to testing, are time-consuming, and require a skilled practitioner.

Electrochemical methods are advantageous in that they are low cost, rapid, highly sensitive, selective, and provide good reproducibility. Several previous reports have described electrochemical methods that are useful for determining L-tyrosine concentrations. A nafion-CeO₂ modified glass-carbon electrode (GCE), an iron (III)-doped zeolite-carbon paste electrode (CPE), and a AuNP (nanoparticle)-MWCNT (multi-walled carbon nanotube)-GCE have been used for L-tyrosine detection in human blood, and a multi-walled carbon nanotubes GCE, a thiolated-β-cyclodextrins gold electrode, and a Boron-doped diamond electrode, have been used to detect L-tyrosine in a pharmaceutical product (See A. S. Razavian, S. M. Ghoreishi, A. S. Esmaeily, M. Behpour, L. M. a. Monzon, J. M. D. Coey, Simultaneous sensing of L-tyrosine and epinephrine using a glassy carbon electrode modified with nafion and CeO2 nanoparticles, Microchim. Acta. (2014); A. Babaei, S. Mirzakhani, B. Khalilzadeh, A Sensitive Simultaneous Determination of Epinephrine and Tyrosine using an Iron(III) Doped Zeolite-Modified Carbon Paste Electrode, J. Braz. Chem. Soc. 20 (2009) 1862-1869; T. Madrakian, E. Haghshenas, A. Afkhami, Simultaneous determination of tyrosine, acetaminophen and ascorbic acid using gold nanoparticles/multiwalled carbon nanotube/glassy carbon electrode by differential pulse voltammetric method, Sensors Actuators B Chem. 193 (2014) 451-460; C. Quintana, S. Suarez, L. Hernandez, Nanostructures on gold electrodes for the development of an 1-tyrosine electrochemical sensor based on host-guest supramolecular interactions, Sensors Actuators B Chem. 149 (2010) 129-135; G. Zhao, Y. Qi, Y. Tian, Simultaneous and Direct Determination of Tryptophan and Tyrosine at Boron-Doped Diamond Electrode, Electroanalysis. 18 (2006) 830-834, each incorporated herein by reference in their entirety). A p-AMT GCE has been tested for its utility in detecting L-tyrosine in human urine (See S. B. Revin, S. A. John, Selective determination of 1-tyrosine in the presence of ascorbic and uric acids at physiological pH using the electropolymerized film of 3-amino-5-mercapto-1,2,4-triazole, Sensors Actuators B Chem. 161 (2012) 1059-1066, incorporated herein by reference in its entirety). However, an electrochemical method for detecting L-tyrosine in a solution with an excellent detection limit, sensitivity, and linear range is urgently needed, since the existing electrochemical methods are not entirely satisfactory in all of the above three aspects.

A graphite pencil electrode offers many attractive features; it is a good conductor of electricity, needs almost no pretreatment, has low cost, is readily available, and has low background current. All of these properties make it a good alternative to the glassy-carbon and gold electrodes (GCE and GE).

Carbon exits in several microstructural forms, such as glassy carbon, diamond, graphite, carbon fibers, carbon dots, graphene, or nanotubes. Each form has its distinct attractive characteristics. Graphene is an allotrope of carbon in the form of a two-dimensional, atomic-scale, hexagonal lattice in which one atom forms each vertex. Graphene is unique due to its excellent electrical conductivity, thermal and mechanical properties, and tremendously large surface area. Graphene also provides a good mechanical strength, being about 200 times stronger than steel by weight, is low in cost, and is simple to produce in large scales (See A. K. Geim, K. S. Novoselov, The rise of graphene., Nat. Mater. 6 (2007) 183-91; Y. Fang, E. Wang, Electrochemical biosensors on platforms of graphene., Chem. Commun. (Camb). 49 (2013) 9526-39; K. Wang, Q. Liu, X.-Y. Wu, Q.-M. Guan, H.-N. Li, Graphene enhanced electrochemiluminescence of CdS nanocrystal for H2O2 sensing., Talanta. 82 (2010) 372-6; H. C. Schniepp, J.-L. Li, M. J. McAllister, H. Sai, M. Herrera-Alonso, D. H. Adamson, et al., Functionalized single graphene sheets derived from splitting graphite oxide., J. Phys. Chem. B. 110 (2006) 8535-9; K. Wang, Q. Liu, Q.-M. Guan, J. Wu, H.-N. Li, J.-J. Yan, Enhanced direct electrochemistry of glucose oxidase and biosensing for glucose via synergy effect of graphene and CdS nanocrystals., Biosens. Bioelectron. 26 (2011) 2252-7, each incorporated herein by reference in their entirety). In particular, graphene has a remarkable electron mobility at room temperature, with reported values in excess of 15000 cm²·V⁻¹·s⁻¹. The corresponding resistivity of the graphene sheet is 10⁻⁶ Ω·cm. This is less than the resistivity of silver, the metal with the lowest known resistivity at room temperature. These attractive features have led to the large-scale use of graphene in catalysis (See N. G. Shang, P. Papakonstantinou, M. McMullan, M. Chu, A. Stamboulis, A. Potenza, et al., Catalyst-Free Efficient Growth, Orientation and Biosensing Properties of Multilayer Graphene Nanoflake Films with Sharp Edge Planes, Adv. Funct. Mater. 18 (2008) 3506-3514; Y. Wang, Y. Li, L. Tang, J. Lu, J. Li, Application of graphene-modified electrode for selective detection of dopamine, Electrochem. Commun. 11 (2009) 889-892, each incorporated herein by reference in their entirety).

It is thus an object of one aspect of the present disclosure to describe a graphene-modified graphite pencil working electrode for detecting and measuring L-tyrosine and a method of making the graphene-modified graphite pencil working electrode using a direct electrochemical reduction method to form reduced-graphene sheets on the surface of a graphite pencil electrode.

### BRIEF SUMMARY OF THE INVENTION

According to a first aspect, the present disclosure relates to a graphene-modified graphite pencil electrode system. The electrode system includes a graphene-modified graphite pencil working electrode comprising a graphite pencil base electrode and a layer of graphene comprising wrinkled graphene sheets on the surface of the graphite pencil base electrode, a counter electrode, and a reference electrode.

In one or more embodiments, the thickness of the wrinkled graphene sheets corresponds to about 1 to about 10 layers of graphene.

In one or more embodiments, the thickness of the wrinkled graphene sheets ranges from about 0.3 nm to 3 nm.

In one or more embodiments, the charge transfer resistance of the graphene-modified graphite pencil working electrode is at least 95% less than the charge transfer resistance of the graphite pencil base electrode as the working electrode.

In one or more embodiments, the electroactive area of the graphene-modified graphite pencil working electrode is at least 5 times as that of the graphite pencil base electrode as the working electrode.

According to a second aspect, the present disclosure relates to a method of detecting L-tyrosine in a solution. The method comprises contacting the solution with the graphene-modified graphite pencil electrode system of the first aspect of the disclosure, and conducting voltammetry, preferably square wave voltammetry, to detect the L-tyrosine concentration in the solution. The conducting square wave voltammetry comprises (a) applying a pulsed potential to the graphene-modified graphite pencil working electrode while sweeping the potential of the graphene-modified graphite pencil working electrode from a potential that is less than an oxidation peak potential of L-tyrosine in the solution and defined as the adsorption potential positively to a potential that is at least the oxidation peak potential of L-tyrosine in the solution, and (b) recording the amount of a forward pulse current and a reverse pulse current during each square wave cycle.

In one or more embodiments, the amplitude of the pulsed potential is about 0.01-0.08 V.

In one or more embodiments, the voltage step of the square wave voltammetry is about 2-10 mV.

In one or more embodiments, the pH of the solution ranges from about 6 to 8.

In one or more embodiments, the frequency of the pulsed potential is about 15-75 Hz.

In one or more embodiments, the adsorption potential of the square wave voltammetry is about 0.0-0.5 V.

In one or more embodiments, the oxidation peak potential of L-tyrosine in the solution ranges from about 0.5 V to about 1.0 V. In one or more embodiments, the sweeping the potential of the graphene-modified graphite pencil working electrode from the adsorption potential is to adsorb the L-tyrosine in the solution to the surface of the graphene-modified graphite pencil working electrode. In some embodiments, the adsorption time is about 60-120 seconds.

In one or more embodiments, the lowest detectable L-tyrosine concentration in the solution is about 0.08 μM.

In one or more embodiments, the solution further comprises at least one selected from the group consisting of phenylalanine, alanine, glucose, fructose, L-methionine, uric acid, ascorbic acid, Na⁺, K⁺, Li⁺, Ni²⁺, SO₄²⁻, and Cl⁻.

In one or more embodiments, the solution comprises at least one selected from the group consisting of whole blood, plasma, serum, saliva, sweat, urine, washes of tissues, extracts of tissues, amniotic fluid, placental fluid, a pharmaceutical composition, and a dietary composition.

In one or more embodiments, the method further comprises plotting the difference in current between the forward pulse current and the reverse pulse current during each square wave cycle, the difference in current represented by I, against the applied potential of the graphene-modified graphite pencil working electrode, the applied potential represented by E, to obtain a square wave voltammogram, and measuring the magnitudes of peak changes in I in the square wave voltammogram. In some embodiments, the magnitude of the peak change in I occurring at the L-tyrosine oxidation peak potential in the square wave voltammogram linearly correlates with the concentration of L-tyrosine ranging from about 1.3 μM to 80 μM in the solution. In some embodiments, the linear relationship between the magnitude of the peak change in I occurring at the L-tyrosine oxidation peak potential in the square wave voltammogram and the concentration of L-tyrosine in the solution is defined by a linear equation, and the slope of the linear equation is at least 1000 μA mM⁻¹.

According to a third aspect, the present disclosure relates to a method of determining an L-tyrosine concentration in a solution. The method comprises contacting the solution with the graphene-modified graphite pencil electrode system of claim 1, and conducting square wave voltammetry to determine the L-tyrosine concentration in the solution. The conducting square wave voltammetry comprises (a) applying a pulsed potential to the graphene-modified graphite pencil working electrode while sweeping the potential of the graphene-modified graphite pencil working electrode from a potential that is less than an oxidation peak potential of L-tyrosine in the solution and defined as the adsorption potential positively to a potential that is at least the oxidation peak potential of L-tyrosine in the solution, and (b) recording the amount of a forward pulse current and a reverse pulse current during each square wave cycle. The square wave voltammetry includes conditions in which: the frequency is 20-30 Hz; the amplitude is 0.01-0.03 V; the voltage step is 2-10 mV; the adsorption potential is 0.0-0.4 V; the adsorption time is 80-100 seconds; and the pH value is 6-8.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram illustrating the simple ripple geometry of the wrinkled graphene sheets.

FIG. 2 is a diagram illustrating the folded geometry of the wrinkled graphene sheets.

FIG. 3 is a diagram illustrating the standing collapsed wrinkle morphology of the wrinkled graphene sheets.

FIG. 4 is an FE-SEM image showing the surface of the bare GPE at 10 μm magnification according to Example 2.

FIG. 5 is an FE-SEM image showing the surface of the bare GPE at 5 μm magnification according to Example 2.

FIG. 6 is an FE-SEM image showing the surface of the bare GPE at 500 nm magnification according to Example 2.

FIG. 7 is an FE-SEM image showing the surface of the GR-modified GPE at 10 μm magnification according to Example 2.

FIG. 8 is an FE-SEM image showing the surface of the GR-modified GPE at 5 μm magnification according to Example 2.

FIG. 9 is an FE-SEM image showing the surface of the GR-modified GPE at 500 nm magnification according to Example 2.

FIG. 10 is a graphical presentation of the electrochemical impedance spectra of the GR-modified GPE represented by line (a), and the bare GPE represented by line (b), in a 0.1 M KCl solution containing 5 mM K₃Fe(CN)₆/K₄Fe(CN)₆ upon application of a 50 mV potential in the frequency range of 100 kHz to 0.01 Hz according to Example 2.

FIG. 11 is a graphical presentation of the magnified version of the electrochemical impedance spectra of the GR-modified GPE shown in FIG. 10 according to Example 2.

FIG. 12 is a graphical presentation of the cyclic voltammograms with the GR-modified GPE as the working electrode in a solution comprising 5 mM K₃Fe(CN)₆/K₄Fe(CN)₆ and 0.1 M KCl and at the scan rates of (a) 20 mV/s, (b) 50 mV/s, (c) 100 mV/s, (d) 200 mV/s, and (e) 300 mV/s according to Example 2.

FIG. 13 is a graphical presentation of the linear relationship between I (μA) and the square root of the scan rate for the cyclic voltammograms obtained with the GR-modified GPE as the working electrode according to FIG. 12 in Example 2.

FIG. 14 is a graphical presentation of the cyclic voltammograms with the bare GPE as the working electrode in a solution comprising 5 mM K₃Fe(CN)₆/K₄Fe(CN)₆ and 0.1 M KCl and at the scan rates of (a) 20 mV/s, (b) 100 mV/s, (c) 200 mV/s, and (d) 300 mV/s according to Example 2.

FIG. 15 is a graphical presentation of the linear relationship between I (μA) and the square root of the scan rate for the cyclic voltammograms obtained with the bare GPE as the working electrode according to FIG. 14 in Example 2.

FIG. 16 is a graphical presentation of the cyclic voltammograms of the bare GPE, represented by line (a); and the GR-modified GPE, represented by line (b), in a PBS solution (0.1 M, pH 7.4) containing 1 mM L-tyrosine and with the scan rate of 100 mV s⁻¹ according to Example 2.

FIG. 17 is a graphical presentation of the square wave voltammograms of the bare GPE, represented by line (a); the bare GPE pretreated with 0.1 M acetate buffer (pH 4.8) containing no graphene oxide under the same cyclic voltammetric conditions for fabricating the GR-modified GPE, represented by line (b); and the GR-modified GPE, represented by line (c), in 0.1 M PBS (pH 7.0) containing 50 μM L-tyrosine according to Example 2. The parameters of the square wave voltammetry were: 0.02 V for the amplitude, 25 Hz for the frequency, and 90 seconds for the adsorption time.

FIG. 18 is a graphical presentation of the square wave voltammograms obtained by using the GR-modified GPE as the working electrode in 0.1 M PBS containing 50 μM L-tyrosine at a pH of 6.5, represented by line (a); at a pH of 7.0, represented by line (b); at a pH of 7.4, represented by line (c); and at a pH of 8.0, represented by line (d) according to Example 3.

FIG. 19 is a graphical presentation of the relationship between the oxidation current peak height of L-tyrosine and the pH of the L-tyrosine containing PBS solutions derived from the square wave voltammograms of FIG. 18 according to Example 3.

FIG. 20 is a graphical presentation of the relationship between the oxidation peak potential of L-tyrosine and the pH of the L-tyrosine containing PBS solutions derived from the square wave voltammograms of FIG. 18 according to Example 3.

FIG. 21 is a graphical presentation of the relationship between the signal-to-noise ratio (S/N) and the amplitude of the pulsed potential of the square wave voltammetry for detecting L-tyrosine in 0.1 M PBS (pH 7.4) containing 50 μM L-tyrosine using the graphene-modified GPE system according to Example 4.

FIG. 22 is a graphical presentation of the relationship between the signal-to-noise ratio (S/N) and the frequency of the pulsed potential of the square wave voltammetry for detecting L-tyrosine in 0.1 M PBS (pH 7.4) containing 50 μM L-tyrosine using the graphene-modified GPE system according to Example 4.

FIG. 23 is a graphical presentation of the relationship between the oxidation current peak height of L-tyrosine and the adsorption time of the square wave voltammetry for detecting L-tyrosine in 0.1 M PBS (pH 7.4) containing 50 μM L-tyrosine using the graphene-modified GPE system according to Example 4.

FIG. 24 is a graphical presentation of the square wave voltammograms obtained by using the GR-modified GPE as the working electrode in 0.1 M PBS (pH 7.4) containing: 0 μM of L-tyrosine, represented by line (a); 1.3 μM of L-tyrosine, represented by line (b); 5 μM of L-tyrosine, represented by line (c); 20 μM of L-tyrosine, represented by line (d); 40 μM of L-tyrosine, represented by line (e); 60 μM of L-tyrosine, represented by line (0; and 80 μM of L-tyrosine, represented by line (g), according to Example 5. The square wave voltammetry parameters included the amplitude of 0.02 V, the frequency of 25 Hz, and the adsorption time of 90 seconds.

FIG. 25 is a graphical presentation of the linear relationship between the oxidation current peak heights of L-tyrosine derived from the square wave voltammograms of FIG. 24 and the corresponding L-tyrosine concentrations according to Example 5, with the coefficient of determination (R²) of 0.9992.

### DETAILED DESCRIPTION OF THE EMBODIMENTS

Disclosed herein are a graphene (GR)-modified graphite pencil electrode (GPE) system and methods of using the system to detect L-tyrosine, especially at a very low concentration, in a solution. The electrode system, which is the first aspect of the disclosure, includes a graphene-modified graphite pencil working electrode comprising a graphite pencil base electrode and a layer of graphene comprising wrinkled graphene sheets on the surface of the graphite pencil base electrode, a counter, or auxiliary, electrode, and a reference electrode.

In some embodiments, the layer of graphene covers at least 70%, preferably at least 80%, more preferably at least 90%, or more preferably at least 95% of the GR-modified GPE surface.

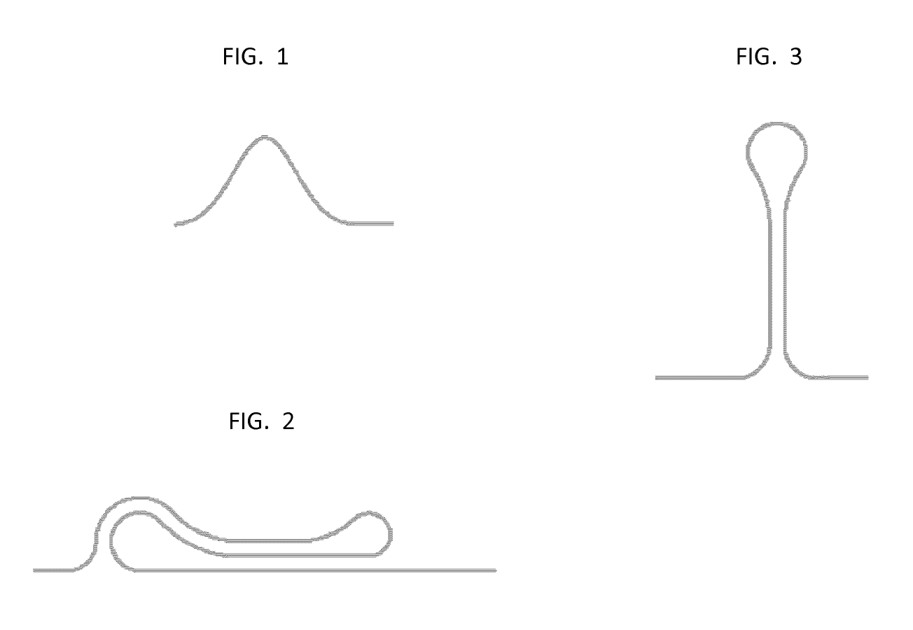

In one embodiment, the layer of graphene covering the surface of the graphene-modified graphite pencil working electrode comprises wrinkled graphene sheets. The wrinkled shape of the graphene sheets increases the surface area of the GR-modified GPE, since the wrinkled graphene sheets are much more stable and do not easily revert to the graphitic form. In some embodiments, the wrinkled morphology of the graphene sheets is the simple ripple geometry as illustrated in FIG. 1. The rippled graphene sheets can be monolayered or multiple-layered. In other embodiments, the wrinkled morphology of the graphene sheets is the folded geometry, an example of which is illustrated in FIG. 2. A simplistic example of the folded wrinkle is a trilayer folded wrinkle, which can be considered to result from a large amount of excess mono-layered graphene in the simple ripple geometry collapsing to form trilayers. In still other embodiments, the wrinkled morphology of the graphene sheets is the standing collapsed wrinkle, an example of which is illustrated in FIG. 3. A simplistic example of the standing collapsed wrinkle is a bilayered standing collapsed wrinkle, which likewise can be considered to result from a large amount of excess mono-layered graphene in the simple ripple geometry collapsing to form bilayers. The widths of the wrinkles on the graphene sheets may vary. In some embodiments, the width may range from about less than 1 nm to about 200 nm. In other embodiments, the width may range from about 5 nm to about 150 nm, from about 10 nm to about 100 nm, or from about 25 nm to about 75 nm. Additionally, the heights of the wrinkles (the distances from the base of the wrinkles to the top of the wrinkles) on the graphene sheets can vary. In some embodiments, the heights may range from about 0.5 nm to about 10 nm. In other embodiments, the heights may range from about 0.9 nm to about 8 nm, or from about 2 nm to about 6 nm.

In some embodiments, the wrinkled graphene sheets have at least 10, preferably at least 50, more preferably at least 100, more preferably at least 250, or more preferably at least 500 wrinkles per 1,000 micrometers of the graphene.

In some embodiments, the graphene sheets covering the surface of the graphene-modified graphite pencil working electrode have an area of 0.2 square millimeters or greater, or 0.5 square millimeters or greater, or 0.8 square millimeters or greater, or 1 square millimeter or greater, or 1.5 square millimeters or greater, or 3 square millimeters or greater.

In some embodiments, the thickness of the layer of graphene covering the surface of the graphene-modified graphite pencil working electrode corresponds to about 1 to about 15 layers of graphene, preferably about 1 to about 10 layers of graphene, preferably about 1 to about 8 layers of graphene, preferably about 1 to about 5 layers of graphene, preferably about 1 to about 3 layers of graphene, or preferably about 1 to about 2 layers of graphene.

In some embodiments, the thickness of the layer of graphene covering the surface of the graphene-modified graphite pencil working electrode ranges from about 0.3 to about 4.5 nm, preferably from about 0.3 to 3 nm, preferably from about 0.3 to 2.4 nm, preferably from about 0.3 to 1.5 nm, preferably from about 0.3 to about 0.9 nm, or preferably from about 0.3 to about 0.6 nm.

In one embodiment, the graphene-modified graphite pencil working electrode may have a distinct interface between the layer of graphene and the surface of the graphite pencil base electrode. In another embodiment, the graphene-modified graphite pencil working electrode has no distinct interface between the layer of graphene and the surface of the graphite pencil base electrode. Rather, the layer of graphene is integrated into or merged with the pencil graphite substrate of the graphite pencil base electrode.

In one embodiment, the pencil graphite substrate of the graphite pencil base electrode is made from beneficiated graphite. In another embodiment, the pencil graphite substrate of the graphite pencil base electrode is made from milled graphite. In still another embodiment, the pencil graphite substrate of the graphite pencil base electrode is made from intercalated graphite, or graphite intercalation compound, non-limiting examples of which include MC₈ (M=K, Rb and Cs), MC₆(M=Li⁺, Sr²⁺, Ba²⁺, Eu²⁺, Yb³⁺, and Ca²⁺), graphite bisulfate, and halogen-graphite compounds.

The graphene-modified graphite pencil working electrode possesses some advantageous characteristics as compared to the graphite pencil base electrode (without a layer of graphene on its surface).

The charge transfer resistance of the graphene-modified graphite pencil working electrode can be determined from the Nyquist plot obtained by electrochemical impedance spectroscopy. In some embodiments, the charge transfer resistance of the graphene-modified graphite pencil working electrode is at least 70%, preferably at least 80%, preferably at least 90%, or more preferably at least 95% less than that of the graphite pencil base electrode as the working electrode.

In some embodiments, the electroactive area of the graphene-modified graphite pencil working electrode is at least 3 times, preferably at least 5 times, more preferably at least 7 times, or more preferably at least 10 times as that of the graphite pencil base electrode as the working electrode.

In some embodiments, the electron transfer rate constant of the graphene-modified graphite pencil working electrode is at least 7 times, preferably at least 10 times, more preferably at least 15 times, more preferably at least 18 times, more preferably at least 25 times, or more preferably at least 30 times as that of the graphite pencil base electrode as the working electrode.

In some embodiments, the oxidation peak current of L-tyrosine on the surface of the graphene-modified graphite pencil working electrode is at least 18 times, preferably at least 25 times, more preferably at least 31 times, more preferably at least 40 times, more preferably at least 50 times, or more preferably at least 60 times as that of the graphite pencil base electrode as the working electrode.

In the disclosed graphene-modified graphite pencil electrode system, the counter electrode, along with the working electrode, provides circuit over which current is measured. The potential of the counter electrode can be adjusted to balance the reaction occurring at the working electrode. The counter electrode can be made of a material that doesn't react with the bulk of the analyte solution and conducts well. The counter electrode of the present disclosure can be fabricated from a conducting or semiconducting material such as platinum, gold, or carbon.

In the disclosed graphene-modified graphite pencil electrode system, the reference electrode provides a stable and well-known electrode potential, against which the potential of the working electrode is measured. The potential of the reference electrode in the electrochemical instrument of the present disclosure is defined as zero (“0”). The potential of the working electrode lower than the reference electrode means the potential is negative, and the potential of the working electrode higher than the reference electrode means the potential is positive. The stability of the reference electrode in the disclosed electrode system is maintained by not passing current over it. The counter electrode passes all the current needed to balance the current observed at the working electrode. In one embodiment, the reference electrode is an Ag/AgCl reference electrode. In another embodiment, the reference electrode is a hydrogen electrode. In another embodiment, the reference electrode is a saturated calomel electrode. In another embodiment, the reference electrode is a copper-copper (II) sulfate electrode. In still another embodiment, the reference electrode is a palladium-hydrogen electrode.

In one embodiment, the graphene-modified graphite pencil electrode system of the present disclosure can have more than three electrodes. For example, it can have two distinct and separate working electrodes, at least one of which is the graphene-modified graphite pencil electrode, and which can be used to scan or hold potentials independently of each other. Both of the electrodes are balanced by a single reference and counter combination for an overall four electrode design.

A second aspect of the disclosure relates to a method of detecting L-tyrosine in a solution. The method includes contacting the solution with the graphene-modified graphite pencil electrode system described in the first aspect, and conducting voltammetry, preferably differential pulse voltammetry, preferably cyclic voltammetry, or more preferably square wave voltammetry, to detect the L-tyrosine concentration in the solution. The square wave voltammetry is conducted by (a) applying a pulsed potential to the graphene-modified graphite pencil working electrode while sweeping the potential of the graphene-modified graphite pencil working electrode from a potential that is less than an oxidation peak potential of L-tyrosine in the solution and defined as the adsorption potential positively to a potential that is at least the oxidation peak potential of L-tyrosine in the solution, and (b) recording the amount of a forward pulse current and a reverse pulse current during each square wave cycle.

In some embodiments, the amplitude of the pulsed potential is about 0.01-0.20 V, preferably about 0.01-0.15 V, more preferably about 0.01-0.10 V, more preferably about 0.01-0.08 V, more preferably about 0.01-0.05 V, more preferably about 0.01-0.03 V, or more preferably about 0.02 V.

In some embodiments, the voltage step of the square wave voltammetry is about 2-10 mV, preferably about 3-8 mV, or more preferably about 3-5 mV.

In some embodiments, the pH of the solution ranges from about 5 to 13, preferably from about 6 to 10, more preferably from about 6 to 8, more preferably from about 6.5 to 7.6, or more preferably about 7.4.

In some embodiments, the frequency of the pulsed potential of the square wave voltammetry is about 10-100 Hz, preferably about 15-75 Hz, more preferably about 20-50 Hz, more preferably about 20-30 Hz, or more preferably about 25 Hz.

In some embodiments, the adsorption potential of the square wave voltammetry is about 0.0-0.5 V, preferably about 0.1-0.4 V, or more preferably about 0.3 V.

In one embodiment, the oxidation peak potential of L-tyrosine in the solution ranges from about 0.4 V to about 1.2 V. In another embodiment, the oxidation peak potential of L-tyrosine in the solution ranges from about 0.5 V to about 1.0 V. In still another embodiment, the oxidation peak potential of L-tyrosine in the solution ranges from about 0.5 V to about 0.7 V.

In one embodiment, the sweeping the potential of the graphene-modified graphite pencil working electrode from the adsorption potential is to adsorb the L-tyrosine in the solution to the surface of the graphene-modified graphite pencil working electrode. In some embodiments, the adsorption time is about 20-200 seconds, preferably about 40-160 seconds, more preferably about 60-120 seconds, or more preferably about 80-100 seconds.

In one embodiment, the lowest detectable L-tyrosine concentration in the solution using the method is about 0.04 μM. In other embodiments, the lowest detectable L-tyrosine concentration in the solution using the method is about 0.06 μM, about 0.08 μM, about 0.1 μM, about 0.2 μM, or about 0.4 μM.

The presence of biomolecules and common ions mostly does not interfere with the detection of L-tyrosine in the solution using the disclosed method. In one embodiment, the solution may further comprise one or more biomolecules such as phenylalanine, alanine, glucose, fructose, L-methionine, uric acid, and ascorbic acid, and/or one or more common ions such as Na⁺, K⁺, Li⁺, Ni²⁺, SO₄²⁻, and Cl⁻. Because of no or low interference from other molecules, the method can be used to detect L-tyrosine in various solutions, comprising at least one selected from whole blood, plasma, serum, saliva, sweat, urine, washes of tissues, extracts of tissues, amniotic fluid, placental fluid, a pharmaceutical composition, and a dietary composition. The pharmaceutical composition may be an L-tyrosine containing pill, capsule, or injection fluid, or may not supposedly contain L-tyrosine and be tested for L-tyrosine contamination, particularly at trace amounts. The dietary composition may be derived from L-tyrosine rich food sources such as cheese, soybeans, beef, lamb, pork, fish, chicken, nuts, seeds, eggs, dairy, beans, and whole grains. L-tyrosine from non-aqueous pharmaceutical and dietary compositions may be first extracted with water or a suitable pH adjusted aqueous solution, such as 0.1 M PBS, pH 7.4, with the resulting L-tyrosine containing extract being optionally diluted, before the L-tyrosine is detected and quantified by the disclosed graphene-modified graphite pencil electrode system and method.

To quantify the concentration of L-tyrosine in the solution, the method can further comprise plotting the difference in current between the forward pulse current and the reverse pulse current during each square wave cycle, the difference in current represented by I, against the applied potential of the graphene-modified graphite pencil working electrode, the applied potential represented by E, to obtain a square wave voltammogram, and measuring the magnitudes of peak changes in I (peak heights) in the square wave voltammogram. If there are other substances in the solution that undergo oxidation within the range of the applied potential of the graphene-modified graphite pencil working electrode during the square wave voltammetry, their oxidation current peaks can be distinguished from the L-tyrosine oxidation current peak in the square wave voltammogram if there is sufficient separation between the oxidation peak potentials of the other substances and the oxidation peak potential of the L-tyrosine in the solution. In some embodiments, the magnitude of the peak change in I occurring at the L-tyrosine oxidation peak potential in the square wave voltammogram linearly correlates with the concentration of L-tyrosine ranging from about 0.5 μM to 160 μM, from about 1 μM to 120 μM, from about 1.3 μM to 80 μM, or from about 2 μM to 60 μM, in the solution.

In some embodiments, the linear relationship between the magnitude of the peak change in I occurring at the L-tyrosine oxidation peak potential in the square wave voltammogram and the concentration of L-tyrosine in the solution is defined by a linear equation, and the slope of the linear equation is at least 500 μA mM⁻¹. In other embodiments, the slope of the linear equation is at least 800 μA mM⁻¹, at least 1000 μA mM⁻¹, at least 1500 μA mM⁻¹, or at least 2000 μA mM⁻¹.

In some embodiments, the method of the present disclosure can be used to detect L-tyrosine derivatives, such as L-DOPA, melanin, and phenylpropanoids.

A third aspect of the disclosure relates to a preferred method of determining an L-tyrosine concentration in a solution. The method comprises contacting the solution with the graphene-modified graphite pencil electrode system of the first aspect, and conducting square wave voltammetry to determine the L-tyrosine concentration in the solution. The square wave voltammetry is conducted by (a) applying a pulsed potential to the graphene-modified graphite pencil working electrode while sweeping the potential of the graphene-modified graphite pencil working electrode from a potential that is less than an oxidation peak potential of L-tyrosine in the solution and defined as the adsorption potential positively to a potential that is at least the oxidation peak potential of L-tyrosine in the solution, and (b) recording the amount of a forward pulse current and a reverse pulse current during each square wave cycle. The square wave voltammetry includes conditions in which: the frequency is 20-30 Hz; the amplitude is 0.01-0.03 V; the voltage step is 2-10 mV; the adsorption potential is 0.0-0.4 V; the adsorption time is 80-100 seconds; and the pH value is 6-8.

Having generally described this invention, a further understanding can be obtained by reference to certain specific examples which are provided herein for purposes of illustration only and are not intended to be limiting unless otherwise specified.

### Example 1

### Preparation of the Graphene (GR)-Modified Graphite Pencil Electrode (GPE)

Graphene oxide (1 mg/mL, Sigma-Aldrich, USA) was dispersed in a 0.1 M acetate buffer at pH 4.8, and a uniform dispersion was obtained by sonicating the solution for 30 minutes. The graphene oxide solution was then transferred into a 3 mL glass cell. The three-electrode system comprising the graphite pencil working electrode (GPE), the platinum wire counter electrode (CHI 115, CH instrument Inc.), and the Ag/AgCl reference electrode (in 3 M KCl, CHI 111, CH instruments Inc.) was inserted through a Teflon cap into the 3 mL glass cell containing the graphene oxide solution. The graphene oxide was electrochemically reduced on the surface of the GPE under a cyclic sweeping potential from −1.4 V to 0.3 V applied at a scan rate of 10 mV/s for 4 cycles. All experiments were conducted at room temperature.

### Example 2

### Morphological and Electrochemical Characterization of the Bare GPE and GR-Modified GPE

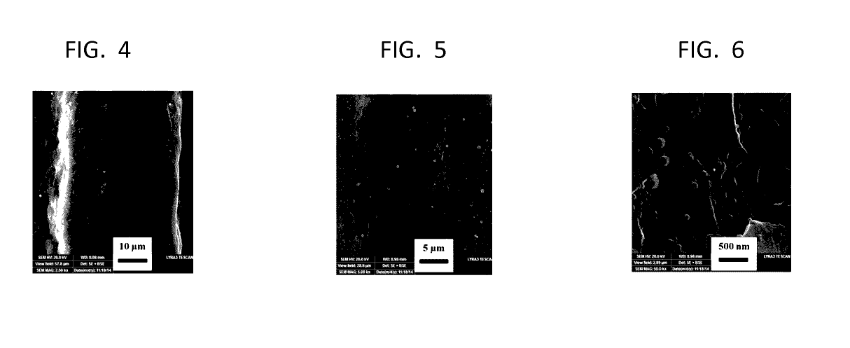

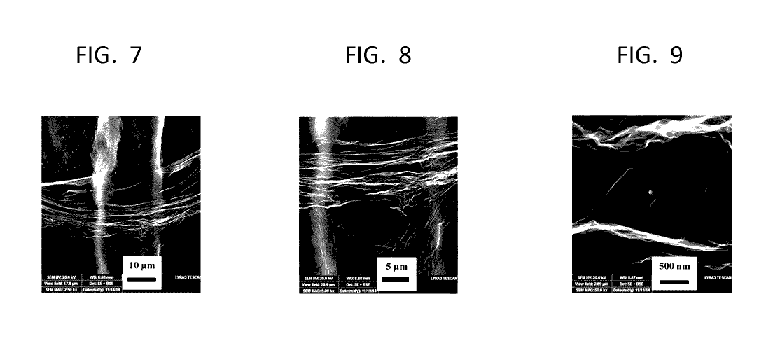

The surface morphologies of the bare GPE, i.e. the graphite pencil base electrode, and GR-modified GPEs were analyzed using field emission scanning electron microscopy (FE-SEM, TESCAN LYRA 3, Brno, Czech Republic). The FE-SEM images were collected from the bare and the GR-modified GPEs at three different magnifications, i.e. 10 μm in FIGS. 4 and 7, 5 μm in FIGS. 5 and 8, and 500 nm in FIGS. 6 and 9, to optically image the electrode surface. FIGS. 4-6 and FIGS. 7-9 show the bare GPE and GR-modified GPE, respectively. A comparison of FIG. 4 showing the bare GPE surface at 10 μm magnification with FIG. 7 showing the GR-modified GPE surface also at 10 μm magnification indicated the formation of the graphene layer on the GPE surface. FIG. 7 reveals that a small region uncovered by graphene was present on the GR-modified GPE surface, whereas the rest of the GR-modified GPE surface was covered by graphene. High-magnification images further revealed the structure of the nanometer thick wrinkled sheets of graphene on the surface of the GR-modified GPE shown in FIGS. 8 and 9. The wrinkled graphene sheets are extremely valuable for increasing the surface area of the electrode because these wrinkled graphene sheets are much more stable and do not easily revert to the graphitic form (See P. K. Aneesh, S. R. Nambiar, T. P. Rao, A. Ajayaghosh, Electrochemically synthesized partially reduced graphene oxide modified glassy carbon electrode for individual and simultaneous voltammetric determination of ascorbic acid, dopamine and uric acid, Anal. Methods. 6 (2014) 5322, incorporated herein by reference in its entirety).

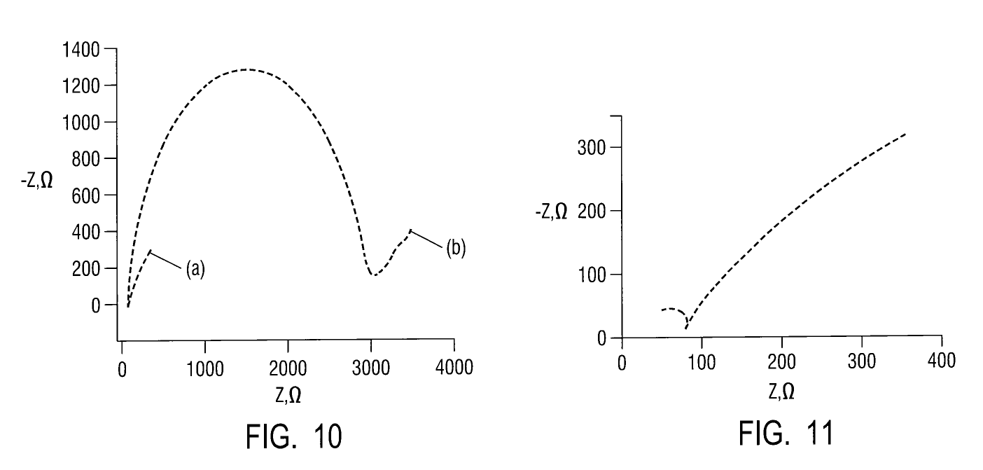

Electrochemical impedance spectroscopy, cyclic voltammetry (CV), and square wave voltammetry (SWV) experiments were performed using an electrochemical workstation (Auto Lab, Netherlands). Electrochemical impedance spectroscopy (EIS) was used to investigate the electrochemical properties of the electrode surface. Electrochemical impedance spectra were recorded from a solution comprising 5 mM K₃Fe(CN)₆/K₄Fe(CN)₆ and 0.1 M KCl. The frequency was varied ranging from 100 kHz to 0.01 Hz. FIG. 10. shows the electrochemical impedance properties of the GR-modified GPE represented by line (a) and the bare GPE represented by line (b). FIG. 11 is the magnified electrochemical impedance spectra of the GR-modified GPE. The Z and −Z axes indicate the real and the imaginary impedance, respectively. The semicircular part of the graph at high frequencies in the Nyquist plot indicates a limiting charge transfer process, whereas the straight line at low frequencies corresponds to a diffusion process. The charge transfer resistance (R_{CT}) was calculated directly from the semicircular Nyquist diagram. The R_{CT} values calculated from the impedance spectra were 2941Ω and 29.68Ω for the bare and GR-modified GPE, respectively. The data indicate that the graphene layer on the surface of the GR-modified GPE significantly reduced the charge transfer resistance compared to the bare GPE.

The electroactive surface area of the bare and GR-modified GPE could be calculated with the help of the Randles-Sevcik equation:

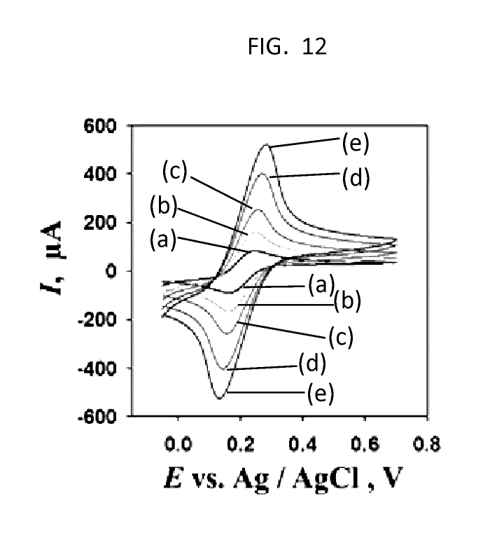

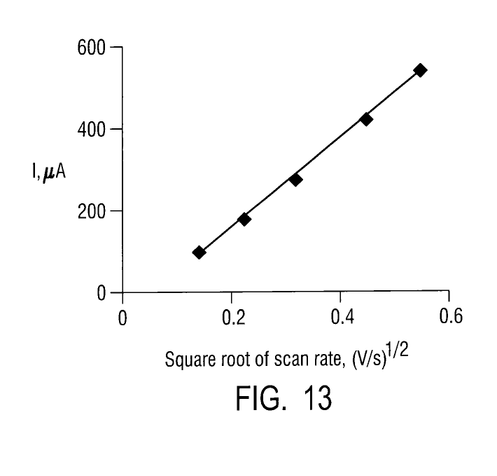

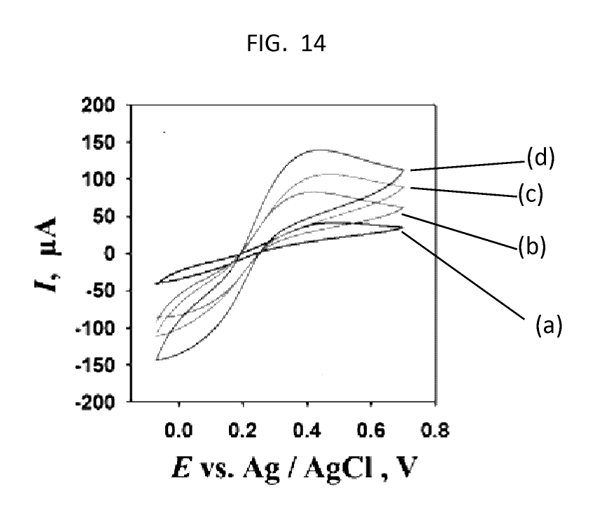

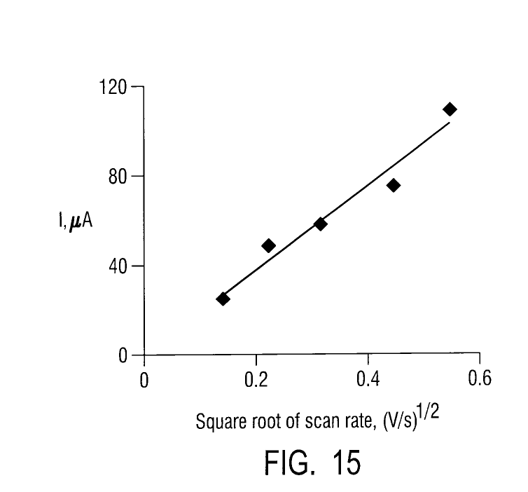

Ip=2.69×10⁵C n^{3/2}A D^{1/2}γ^{1/2}, [1]

where C is the concentration of the analyte (mol L⁻¹), n is the number of electrons that contribute to the redox reaction on the electrode surface, A is the electroactive surface area of the electrode (cm²), D is the diffusion coefficient (cm²s⁻¹), and γ is the scan rate (Vs⁻¹). The electroactive surface area was calculated from the cyclic voltammetry (CV) scans recorded at the scan rates between 20 mV/s and 300 mV/s using the GR-modified GPE shown in FIGS. 12 and 13 or the bare GPE shown in FIGS. 14 and 15 from a solution comprising 5 mM K₃Fe(CN)₆/K₄Fe(CN)₆ and 0.1 M KCl. The electroactive areas calculated using Equation 1 were 0.293 cm² and 0.050 cm² for the GR-modified GPE and the bare GPE, respectively.

The electron transfer rate constants (k) of the bare and the GR-modified GPE were calculated using Equation 2 (See K. I. Ozoemena, Anodic Oxidation and Amperometric Sensing of Hydrazine at a Glassy Carbon Electrode Modified with Cobalt (II) Phthalocyanine-cobalt (II) Tetraphenylporphyrin (CoPc-(CoTPP)4) Supramolecular Complex, Sensors. 6 (2006) 874-891; V. Ganesh, S. K. Pal, S. Kumar, V. Lakshminarayanan, Self-assembled monolayers (SAMs) of alkoxycyanobiphenyl thiols on gold—a study of electron transfer reaction using cyclic voltammetry and electrochemical impedance spectroscopy., J. Colloid Interface Sci. 296 (2006) 195-203, each incorporated by reference in their entirety),

R_{CT}=R T/F²n²k A C,

k=R T/F²n²A C R_{CT} [2]

where R_{CT} is the charge transfer resistance, T is the temperature, R is the gas constant, F is the Faraday constant, n is the number of electrons, A is the electroactive area of the electrode, and C is the concentration. The calculated electron transfer rate constants (k) of the bare and GR-modified GPE were 3.62×10⁻⁴ cm s⁻¹ and 6.12×10⁻³ cm s⁻¹, respectively. The higher k value for the GR-modified GPE indicated that its electron transfer process was much faster than that of the bare GPE.

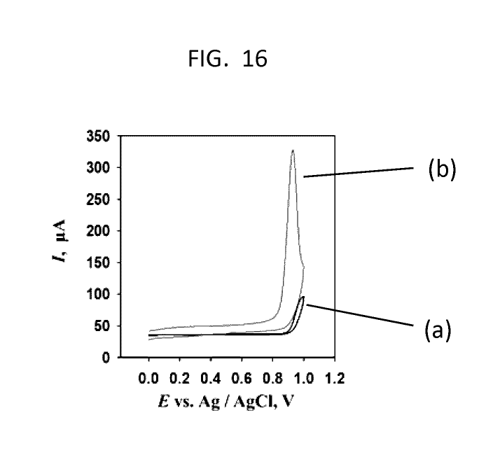

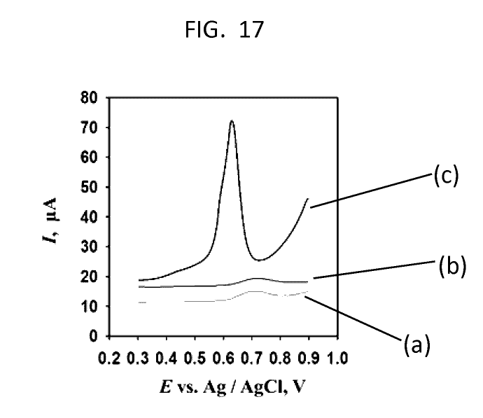

Further electrochemical studies were performed using cyclic voltammetry and square wave voltammetry in L-tyrosine containing phosphate-buffered saline (PBS, 0.1 M, pH 7.4) solutions. Referring to FIG. 16, the oxidation peak current response with the GR-modified GPE in a solution containing 1 mM L-tyrosine represented by line (b) was more dramatic as compared to the response with the bare GPE represented by line (a). The oxidation peak current with the GR-modified GPE was 31 times the oxidation peak current with the bare GPE. Referring to FIG. 17, similar results were obtained using square wave voltammetry. The electrochemical response to the 0.1 M PBS solution (pH 7.4) containing 50 μM L-tyrosine was much stronger with the GR-modified GPE represented by line (c) than with the bare GPE represented by line (a).

Since the graphene oxide solution was prepared in a 0.1 M acetate buffer (pH 4.8), it was possible that the acetate pretreatment may have affected the electrochemical properties of the graphene-modified GPE. This possibility was tested by pretreating the bare GPE in the 0.1 M acetate buffer (pH 4.8) containing no graphene oxide with a cyclic sweeping potential from −1.4 V to 0.3 V applied at a scan rate of 10 mV/s over 4 cycles, the same set of conditions except for the presence of graphene oxide under which graphene oxide was electrochemically reduced on the surface of the GPE to fabricate the graphene-modified GPE. Referring to FIG. 17, like the bare GPE represented by line (a), the bare GPE pretreated with the 0.1 M acetate buffer containing no graphene oxide under the cyclic sweeping potential represented by line (b) did not display a discernible oxidation peak current of L-tyrosine. Graphene oxide (GO) acts as an insulator rather than as a conductor, whereas reduced graphene oxide is an excellent conductor (See Y. Fang, E. Wang, Electrochemical biosensors on platforms of graphene., Chem. Commun. (Camb). 49 (2013) 9526-39. incorporated by reference in their entirety). The morphological and electrochemical results agreed well with one another. Graphene oxide appeared to have been successfully reduced on the GR-modified GPE surface, resulting in the GR-modified GPE with enhanced electroactivity, sensitivity, and increased electroactive surface area as compared to the bare GPE.

### Example 3

### The Effect of pH on the Detection of L-Tyrosine in a Solution Using the Graphene-Modified Graphite Pencil Electrode System and Square Wave Voltammetry (SWV)

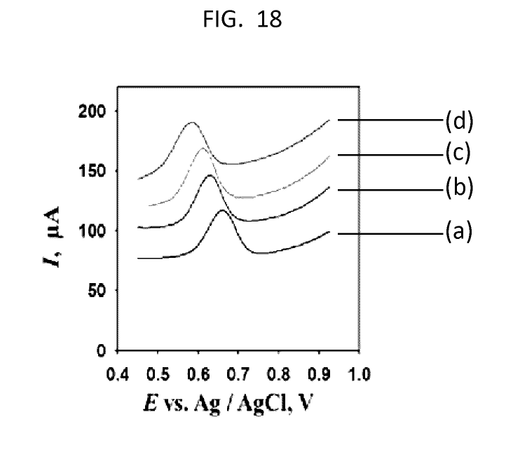

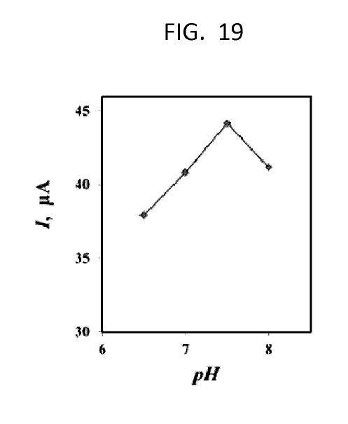

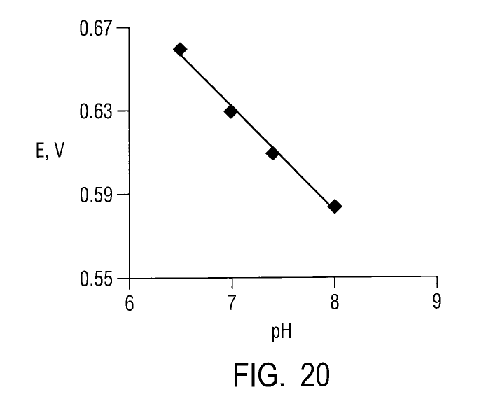

The effect of pH on the detection of L-tyrosine in a solution using the graphene-modified graphite pencil electrode system and square wave voltammetry was examined in a PBS solution (0.1 M) containing 50 μM of L-tyrosine at a pH ranging from 6.5 to 8.0 determined by a pH meter (Accumet® XL50), with the results presented in FIG. 18. pH significantly affected the oxidation peak current of L-tyrosine as well as the peak height corresponding to the magnitude of the peak change in I occurring at the oxidation peak potential of L-tyrosine in the square wave voltammograms shown in FIG. 18, where I is the difference in current between the two current measurements during each square wave cycle, one at the end of the forward pulse, and the other at the end of the reverse pulse. In addition to the oxidation peak current presented in FIG. 18 and the peak height presented in FIG. 19, the oxidation peak potential of L-tyrosine also changed with pH shown in FIG. 20. Referring to FIG. 19, the oxidation current peak height increased as the pH increased and reached its maximum value at pH 7.4. Further increases in the pH reduced the oxidation current peak height. Referring to FIG. 20, the oxidation peak potential of L-tyrosine decreased linearly with the increasing pH. The negative shift in the oxidation peak potential of L-tyrosine with the increasing pH indicated that protons were directly involved in L-tyrosine oxidation. The slope of the linear graph (R²=0.991) of the oxidation peak potential of L-tyrosine vs. pH, as shown in FIG. 20, was −50.1 mV, which is near the theoretical value of −59 mV. This slope indicated that equal numbers of protons and electrons were involved in the process of charge transfer on the surface of the GR-modified GPE. Equation 3 shows the inverse linear relationship between the oxidation peak potential of L-tyrosine and pH.

E vs. Ag/AgCl=0.9829−0.0501[pH] [3]

The electrooxidation of tyrosine at the GR-modified GPE appeared to be a one-electron and one-proton process, in agreement with the previous reports (See Y. Fan, J.-H. Liu, H.-T. Lu, Q. Zhang, Electrochemistry and voltammetric determination of L-tryptophan and L-tyrosine using a glassy carbon electrode modified with a Nafion/TiO2-graphene composite film, Microchim. Acta. 173 (2011) 241-247; Q. Xu, S.-F. Wang, Electrocatalytic Oxidation and Direct Determination of L-Tyrosine by Square Wave Voltammetry at Multi-wall Carbon Nanotubes Modified Glassy Carbon Electrodes, Microchim. Acta. 151 (2005) 47-52; A. S. Razavian, S. M. Ghoreishi, A. S. Esmaeily, M. Behpour, L. M. a. Monzon, J. M. D. Coey, Simultaneous sensing of L-tyrosine and epinephrine using a glassy carbon electrode modified with nafion and CeO2 nanoparticles, Microchim. Acta. (2014), each incorporated by reference in their entirety).

### Example 4

### Determination of the SWV Parameters to Detect L-Tyrosine in a Solution Using the Graphene-Modified GPE System

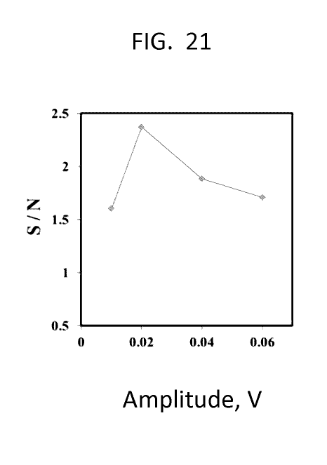

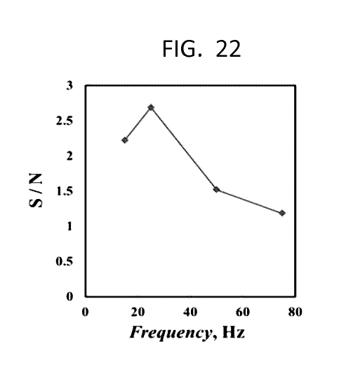

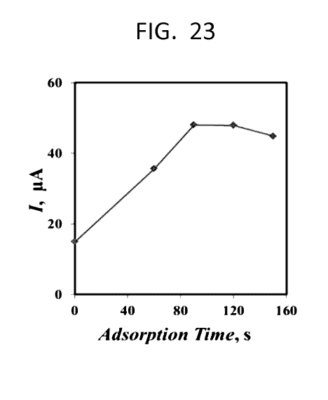

The SWV amplitude of the pulsed potential was first set between 0.01 V and 0.08 V, as this parameter significantly impacted the oxidation signal of L-tyrosine using the graphene-modified GPE system. Referring to FIG. 21, as the amplitude increased, the signal-to-noise (S/N) ratio also increased. The maximum S/N ratio was obtained at the amplitude of 0.02 V, with a further increase in amplitude resulting in a continuous decline in the S/N ratio. Next, the frequency of the pulsed potential of the SWV was set between 15 and 75 Hz. The frequency affected both the L-tyrosine oxidation signal strength and the signal noise. Referring to FIG. 22, the highest S/N ratio was obtained at the frequency of 25 Hz. Finally, the L-tyrosine adsorption time on the GR-modified GPE surface at the adsorption potential of about 0.0 V was set. The adsorption time influenced the sensitivity and the strength of the signal. Referring to FIG. 23, the oxidation current peak height of L-tyrosine increased as the adsorption time increased, indicating that L-tyrosine adsorbed onto the surface of the graphene-modified GPE. The electrode surface appeared to become saturated at 90 seconds, since no further increase in the oxidation current peak height occurred when the adsorption time went above 90 seconds. Thus, the preferred square wave voltammetry conditions included the amplitude of 0.02 V, the frequency of 25 Hz, the adsorption time of 90 seconds, the voltage step of 5 mV, the adsorption potential of 0.0 V, and the range of the scanned potential of 0.3-0.9V.

### Example 5

### Determination of the Calibration Curve, the Detection Limit, and Reproducibility for Measuring an L-Tyrosine Concentration in a Solution Using the Graphene-Modified GPE System and SWV

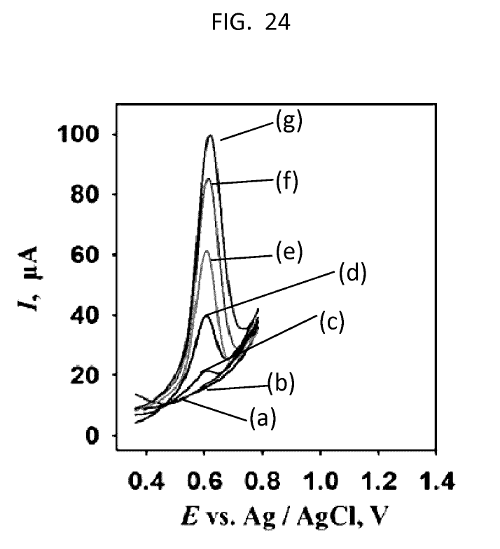

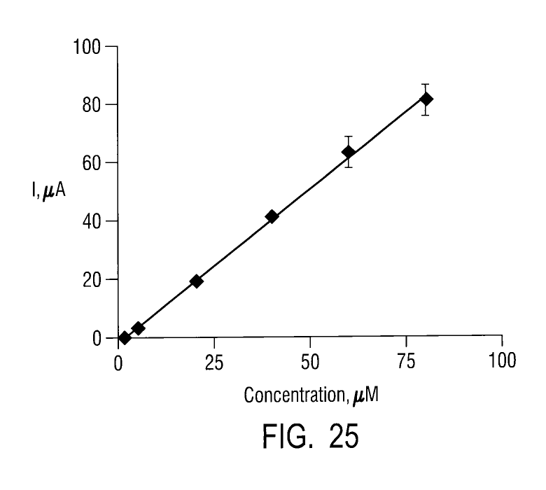

A calibration curve for measuring an L-tyrosine concentration in a solution was constructed using the graphene-modified GPE system and SWV with the preferred parameters, including the amplitude of 0.02 V, the frequency of 25 Hz, and the adsorption time of 90 seconds. Referring to FIGS. 24 and 25, the oxidation current peak heights (I) in the square wave voltammograms and the L-tyrosine concentrations (C_{Tyr}) ranging from 1.3 μM and 80 μM in the PBS solution were linearly correlated (n=3). The linear equation I (μA)=1.0434 C_{Tyr} (μM)−1.2022 was obtained by linear regression, with the coefficient of determination (R²) of 0.9992. The graphene-modified GPE system exhibited a high sensitivity of 1043 μA mM⁻¹ (as indicated by the slope of the linear equation), which is much higher than the sensitivities reported previously and shown in Table 1. The detection limit using the graphene-modified GPE system and SWV was 0.08 μM (n=9). The high sensitivity and low detection limit indicated that the graphene on the GR-modified-GPE surface significantly enhanced the electroactivity for L-tyrosine.

The reproducibility of using the graphene-modified GPE system to determine an L-tyrosine concentration in a solution was examined by fabricating five GR-modified GPEs under the same set of conditions. Small deviations in the oxidation peak current were observed using a 0.1 M PBS (pH 7.4) solution containing 50 μM of L-tyrosine, with a relative standard deviation (RSD) of 4.95% (n=5). This small RSD value indicated the excellent reproducibility of the OR-modified GPE.

TABLE 1
Comparison of the GR-modified GPE properties to those of other modified
electrodes for the determination of L-tyrosine in a sample.

| | LOD | Sensitivity | Linear | Correlation | |
|---|---|---|---|---|---|
| Electrode | (μM) | (μAmM⁻¹) | Range (μM) | coefficient | Ref. |
| Nafion-TiO₂-GR-GCE | 2.3 | 22.8 | 10-160 | 0.9941 | [a] |
| Nafion-CeO₂-GCE | 0.09 | 200 | 2-160 | 0.9973 | [b] |
| BuCh-GCE | 0.4 | — | 4-100 | — | [c] |
| CNF-CPE | 0.1 | 10.7 | 0.2-109 | 0.9985 | [d] |
| MWNTs-GCE | 0.4 | 52 | 2-500 | 0.9967 | [e] |
| Fe³⁺/ZMCPE | 0.32 | 9.3454 | 1.2-90 | 0.9989 | [f] |
| B-doped diamond | 1 | 9.79 | 100-700 | 0.9972 | [g] |
| electrode | | | | | |
| MWCNTs-GNS/GCE | 0.19 | 9 | 0.90-95.4 | 0.9900 | [h] |
| Ag/Rutin/WGE | 0.07 | — | 0.3-10 | 0.9850 | [i] |
| Screen Printed ES | — | 8 | 50-500 | 0.9980 | [j] |
| SWCNT arrayed-Pt | 0.1 | 8 | 0.1-100 | 0.9996 | [k] |
| Thiolated/β-cyclodextrins/ | 12 | 1.69 | 36-240 | 0.9970 | [l] |
| gold electrode | | | | | |
| GR-modified GPE | 0.08 | 1043 | 1.3-80 | 0.9992 | This |
| | | | | | disclosure |

[a] Y. Fan, J.-H. Liu, H.-T. Lu, Q. Zhang, Electrochemistry and voltammetric determination of L-tryptophan and L-tyrosine using a glassy carbon electrode modified with a Nafion/TiO2-graphene composite film, Microchim. Acta. 173 ( 2011) 241-247. Incorporated herein by reference in its entirety.
[b] A. S. Razavian, S. M. Ghoreishi, A. S. Esmaeily, M. Behpour, L. M. a. Monzon, J. M. D. Coey, Simultaneous sensing of L-tyrosine and epinephrine using a glassy carbon electrode modified with nafion and CeO2 nanoparticles, Microchim. Acta. (2014). Incorporated herein by reference in its entirety.
[c] G.-P. Jin, X.-Q. Lin, The electrochemical behavior and amperometric determination of tyrosine and tryptophan at a glassy carbon electrode modified with butyrylcholine, Electrochem. Commun. 6 (2004) 454-460. Incorporated herein by reference in its entirety.
[d] X. Tang, Y. Liu, H. Hou, T. You, Electrochemical determination of L-Tryptophan, L-Tyrosine and L-Cysteine using electrospun carbon nanofibers modified electrode., Talanta. 80 (2010) 2182-6. Incorporated herein by reference in its entirety.
[e] Q. Xu, S.-F. Wang, Electrocatalytic Oxidation and Direct Determination of L-Tyrosine by Square Wave Voltammetry at Multi-wall Carbon Nanotubes Modified Glassy Carbon Electrodes, Microchim. Acta. 151 (2005) 47-52. Incorporated herein by reference in its entirety.
[f] A. Babaei, S. Mirzakhani, B. Khalilzadeh, A Sensitive Simultaneous Determination of Epinephrine and Tyrosine using an Iron(III) Doped Zeolite-Modified Carbon Paste Electrode, J. Braz. Chem. Soc. 20 (2009) 1862-1869. Incorporated herein by reference in its entirety.
[g] G. Zhao, Y. Qi, Y. Tian, Simultaneous and Direct Determination of Tryptophan and Tyrosine at Boron-Doped Diamond Electrode, Electroanalysis. 18 (2006) 830-834. Incorporated herein by reference in its entirety.
[h] M. Arvand, T. M. Gholizadeh, Simultaneous voltammetric determination of tyrosine and paracetamol using a carbon nanotube-graphene nanosheet nanocomposite modified electrode in human blood serum and pharmaceuticals., Colloids Surf. B. Biointerfaces. 103 (2013) 84-93. Incorporated herein by reference in its entirety.
[i] G.-P. Jin, X. Peng, Q.-Z. Chen, Preparation of Novel Arrays Silver Nanoparticles Modified Polyrutin Coat-Paraffin-Impregnated Graphite Electrode for Tyrosine and Tryptophan's Oxidation, Electroanalysis. 20 (2008) 907-915. Incorporated herein by reference in its entirety.
[j] M. Vasjari, A. Merkoçi, J. P. Hart, S. Alegret, Amino Acid Determination Using Screen-Printed Electrochemical Sensors, Microchim. Acta. 150 (2005) 233-238. Incorporated herein by reference in its entirety.
[k] J. Okuno, K. Maehashi, K. Matsumoto, K. Kerman, Y. Takamura, E. Tamiya, Single-walled carbon nanotube-arrayed microelectrode chip for electrochemical analysis, Electrochem. Commun. 9 (2007) 13-18. Incorporated herein by reference in its entirety.
[I] C. Quintana, S. Suárez, L. Hernández, Nanostructures on gold electrodes for the development of an l-tyrosine electrochemical sensor based on host-guest supramolecular interactions, Sensors Actuators B Chem. 149 (2010) 129-135. Incorporated herein by reference in its entirety.

### Example 6

### Determination of Interference from Other Analytes with Detecting L-Tyrosine Concentrations and Determination of L-Tyrosine Concentrations in Human Urine Samples Using the Graphene-Modified GPE System and SWV

Interference from other analytes with the sensitivity of L-tyrosine detection using the graphene-modified GPE system and SWV was examined. Biomolecules, such as phenylalanine, alanine, glucose, fructose, L-methionine, uric acid, and ascorbic acid, and common ions, such as Na⁺, K⁺, Li⁺, Ni²⁺, SO₄²⁻ and Cl⁻, were tested for their interfering effects on the detection of L-tyrosine. Most of the agents tested introduced small variations in the oxidation peak current of L-tyrosine, on the order of 0.3-12%. The graphene-modified GPE system was then tested to measure L-tyrosine concentrations in a real human urine sample collected from a healthy individual. Prior to the analysis, the urine sample was diluted 200 times in 0.1 M PBS buffer (pH 7.4). The diluted urine sample was spiked with L-tyrosine to have a final L-tyrosine concentration of 40, 50, or 60 μM, and its L-tyrosine concentration was measured by the graphene-modified GPE system and SWV under the preferred SWV conditions. The voltammograms yielded two well-defined current peaks: one corresponding to uric acid and the other corresponding to L-tyrosine at its oxidation peak potential of +0.6 V. Referring to Table 2, the comparison between the added L-tyrosine concentrations and the L-tyrosine concentrations detected by the graphene-modified GPE system indicated the recovery rates ranging from 89% to 95%. These results indicate that the GR-modified electrode may be useful for tyrosine detection in urine, which tends to include impurities and interfering species.

TABLE 2
Determination of L-tyrosine in human urine samples

| Sample# | Added (μM) | Found (μM) | Recovery (%) |
|---|---|---|---|
| 1 | 40 | 37.2 | 93 |
| 2 | 50 | 47.4 | 95 |
| 3 | 60 | 53.4 | 89 |

1. A graphene-modified graphite pencil electrode system, comprising:
a graphene-modified graphite pencil working electrode comprising a graphite pencil base electrode and a layer of graphene on the surface of the graphite pencil base electrode, wherein the layer of graphene comprises wrinkled graphene sheets,
a counter electrode, and
a reference electrode.

2. The graphene-modified graphite pencil electrode system of claim 1, wherein the thickness of the wrinkled graphene sheets corresponds to about 1 to about 10 layers of graphene.

3. The graphene-modified graphite pencil electrode system of claim 1, wherein the thickness of the wrinkled graphene sheets ranges from about 0.3 nm to 3 nm.

4. The graphene-modified graphite pencil electrode system of claim 1, wherein the charge transfer resistance of the graphene-modified graphite pencil working electrode is at least 95% less than the charge transfer resistance of the graphite pencil base electrode as the working electrode, and wherein the electroactive area of the graphene-modified graphite pencil working electrode is at least 5 times as that of the graphite pencil base electrode as the working electrode.

5. A method of detecting L-tyrosine in a solution, comprising:
contacting the solution with the graphene-modified graphite pencil electrode system of claim 1, and
conducting square wave voltammetry to detect the L-tyrosine concentration in the solution, wherein the conducting square wave voltammetry comprises:
(a) applying a pulsed potential to the graphene-modified graphite pencil working electrode while sweeping the potential of the graphene-modified graphite pencil working electrode from a potential that is less than an oxidation peak potential of L-tyrosine in the solution and defined as the adsorption potential positively to a potential that is at least the oxidation peak potential of L-tyrosine in the solution, and
(b) recording the amount of a forward pulse current and a reverse pulse current during each square wave cycle.

6. The method of claim 5, wherein the amplitude of the pulsed potential is about 0.01-0.08 V.

7. The method of claim 5, wherein the voltage step of the square wave voltammetry is about 2-10 mV.

8. The method of claim 5, wherein the pH of the solution ranges from about 6 to 8.

9. The method of claim 5, wherein the frequency of the pulsed potential is about 15-75 Hz.

10. The method of claim 5, wherein the adsorption potential of the square wave voltammetry is about 0.0-0.5 V.

11. The method of claim 5, wherein the oxidation peak potential of L-tyrosine in the solution ranges from about 0.5 V to about 1.0 V.

12. The method of claim 5, wherein the sweeping the potential of the graphene-modified graphite pencil working electrode from the adsorption potential is to adsorb the L-tyrosine in the solution to the surface of the graphene-modified graphite pencil working electrode.

13. The method of claim 12, wherein the adsorption time is about 60-120 seconds.

14. The method of claim 5, wherein the lowest detectable L-tyrosine concentration in the solution is about 0.08 μM.

15. The method of claim 5, wherein the solution further comprises at least one selected from the group consisting of phenylalanine, alanine, glucose, fructose, L-methionine, uric acid, ascorbic acid, Na⁺, K⁺, Li⁺, Ni²⁺, SO₄²⁻, and Cl⁻.

16. The method of claim 5, wherein the solution comprises at least one selected from the group consisting of whole blood, plasma, serum, saliva, sweat, urine, washes of tissues, extracts of tissues, amniotic fluid, placental fluid, a pharmaceutical composition, and a dietary composition.

17. The method of claim 5, further comprising plotting the difference in current between the forward pulse current and the reverse pulse current during each square wave cycle, the difference in current represented by I, against the applied potential of the graphene-modified graphite pencil working electrode, the applied potential represented by E, to obtain a square wave voltammogram, and measuring the magnitudes of peak changes in I in the square wave voltammogram.

18. The method of claim 17, wherein the magnitude of the peak change in I occurring at the L-tyrosine oxidation peak potential in the square wave voltammogram linearly correlates with the concentration of L-tyrosine ranging from about 1.3 μM to 80 μM in the solution.

19. The method of claim 18, wherein the linear relationship between the magnitude of the peak change in I occurring at the L-tyrosine oxidation peak potential in the square wave voltammogram and the concentration of L-tyrosine in the solution is defined by a linear equation, and wherein the slope of the linear equation is at least 1000 μA mM⁻¹.

20. A method of determining an L-tyrosine concentration in a solution, comprising:
contacting the solution with the graphene-modified graphite pencil electrode system of claim 1, and
conducting square wave voltammetry to determine the L-tyrosine concentration in the solution, wherein the conducting square wave voltammetry comprises:
(a) applying a pulsed potential to the graphene-modified graphite pencil working electrode while sweeping the potential of the graphene-modified graphite pencil working electrode from a potential that is less than an oxidation peak potential of L-tyrosine in the solution and defined as the adsorption potential positively to a potential that is at least the oxidation peak potential of L-tyrosine in the solution, and
(b) recording the amount of a forward pulse current and a reverse pulse current during each square wave cycle,
wherein the square wave voltammetry includes conditions in which: the frequency is 20-30 Hz; the amplitude is 0.01-0.03 V; the voltage step is 2-10 mV; the adsorption potential is 0.0-0.4 V; the adsorption time is 80-100 seconds; and the pH value is 6-8.
